(19) United States
(12) Patent Application Publication
(10) Pub. No.: US 2024/0010027 A1
(43) Pub. Date: Jan. 11, 2024

(54) VEHICLE WHEEL HAVING MULTI-GLOSS FINISH

(71) Applicant: SUPERIOR INDUSTRIES INTERNATIONAL INC., Southfield, MI (US)

(72) Inventor: HENRY CLAY CHENAULT, III, (US)

(73) Assignee: SUPERIOR INDUSTRIES INTERNATIONAL INC., Southfield, MI (US)

(21) Appl. No.: 18/025,821

(22) PCT Filed: Sep. 21, 2021
(86) PCT No.: PCT/US2021/051296

§ 371 Date: Mar. 10, 2023

Related U.S. Application Data
(60) Provisional application No. 63/081,118, filed on Sep. 21, 2020.

(51) Int. Cl. B60B 3/10

(52) U.S. Cl. CPC B60B 3/10; B60B 2310/614; B60B 2310/616

(57) ABSTRACT

A vehicle wheel includes a face portion including a central portion defining a Wheel axis and a plurality of spokes extending radially outwardly from the face portion. A rim portion circumscribes the wheel axis and is interconnected to the face portion by the plurality of spokes. The face portion and the rim portion define a first surface and a second surface. The first surface includes a paint finish defining a first gloss rating and the second surface includes a paint finish. defining a second gloss rating that is different than the first gloss rating presenting a multi-gloss paint finish to the wheel.

### PRIOR APPLCIATIONS

The present application claims priority to international Patent Application No.: PCT/US2021/051296 filed Sep. 21, 2021 which claims priority to United. States Provisional Patent Application No. 63/081,118 filed on Sep. 21, 2020, the contents of which are incorporated herein by reference.

### TECHNICAL FIELD

The present application relates generally toward a wheel and method of manufacturing a wheel providing an improved appearance. More specifically, the present application relates toward a wheel and a method of coating a wheel providing multiple gloss levels.

BACKGROUND

Vehicle wheels have become an increasingly important aspect of overall passenger vehicle appearance. As such, wheel manufacturers have looked for innovative technical solutions to provide a distinguishing appearance to the wheel. Two-tone, multi-color, unique spoke characteristics have all proven unsuccessful for to present a distinctive wheel appearance for a variety of technical and economic issues. This effort continues but further developments are necessary.

The primary manner in which a two-tone type appearance is achieved is by applying a first layer of paint to a wheel, then milling or turning a wheel to remove the first layer of paint to expose a wheel substrate. The milling or turning creates a smooth surface that presents as a shiny surface. Once the milling or turning is complete, a clear coating is applied to the entire wheel. While the milled portion gives an illusion of being glossier than the as-cast portions of the wheel, the gloss rating is the same. While a wheel comprising a single gloss level is industry standard, there is a desire to provide a wheel having multiple gloss ratings providing distinguishing characteristics to the wheel without having to machine painted surfaces or otherwise adopt impractical solutions.

### SUMMARY

A vehicle wheel includes a face portion including a central portion defining a wheel axis and a plurality of spokes extending radially outwardly from the face portion. A rim portion circumscribes the wheel axis and is interconnected to the face portion by the plurality of spokes. The face portion and the rim portion define a first surthce and a second surface. The first surface includes a paint finish defining a first gloss rating and the second surface includes a paint finish defining a second gloss rating that is different than the first gloss rating presenting a multi-gloss paint finish to the wheel.

Modern vehicle styling seeks to meet differing consumer desires, some of which rely on visibly differing gloss levels of a paint finish on vehicle components. These levels are typically classified as high gloss, medium or semi-gloss to a matted or low gloss appearance. Gloss is assigned a rating from measurements typically taken by a gloss meter. The gloss meter establishes a gloss rating by measuring specular reflection at a surface of the wheel. Gloss is determined by projecting a beam of light at a fixed intensity and angle onto a surface and measuring the amount of reflected light at an equal but opposite angle. By way of general example, a high gloss rating ranges includes gloss unit rating between about 80 to 100. A medium gloss rating include a gloss unit rating between about 10 to 80. A matted gloss rating ranges includes a gloss unit rating between about 0 and 10. These rating ranges may very and are provide only as an. example. Applying a polymer coating having a first gloss rating over a polymer coating having a second. gloss rating provides a wheel with an overall paint finish having two different levels of gloss and a unique appearance. Further, the appearance that an overall paint finish provides two different gloss ratings is achievable for the first time on non-planar surfaces of the vehicle Wheel eliminating the requirement to turn or mill a Wheel where one of the surfaces must be substantially planar to provide an illusion of multiple gloss ratings.

### BRIEF DESCRIPTION OF THE DRAWINGS

Other advantages of the present invention will be readily appreciated, as the same becomes better understood by reference to the following detailed description when considered in connection with the accompanying drawings, Mierein:

FIG. 1 shows a perspective view of a wheel presenting a first surface with a first gloss rating and a second surface with a second gloss rating;

FIG. 2 shows a cross-sectional view of a vehicle wheel of the present invention;

FIG. 3 shows a flow chart of a coating process of a vehicle wheel used to obtain a multi-gloss appearance;

FIG. 4 shows perspective view of a wheel having a mask positioned in place covering a first surface of the vehicle wheel having a first gloss rating;

FIG. 5 shows a partial cross-sectional view of a mask positioned over the vehicle wheel; and

FIG. 6 shows a partial cross-sectional view of a mask disposed in an alternative position of the vehicle wheel.

### DETAILED DESCRIPTION

The method of coating a vehicle wheel of the present invention provides an enhanced appearance by providing an. overall paint finish having two or more different gloss levels to the vehicle wheel. While the application references an alloy wheel, the intent is to include multiple wheel configurations including, forged, composite and hybrid alloy-composite wheels, all of which are within the scope of the, invention of the present application.

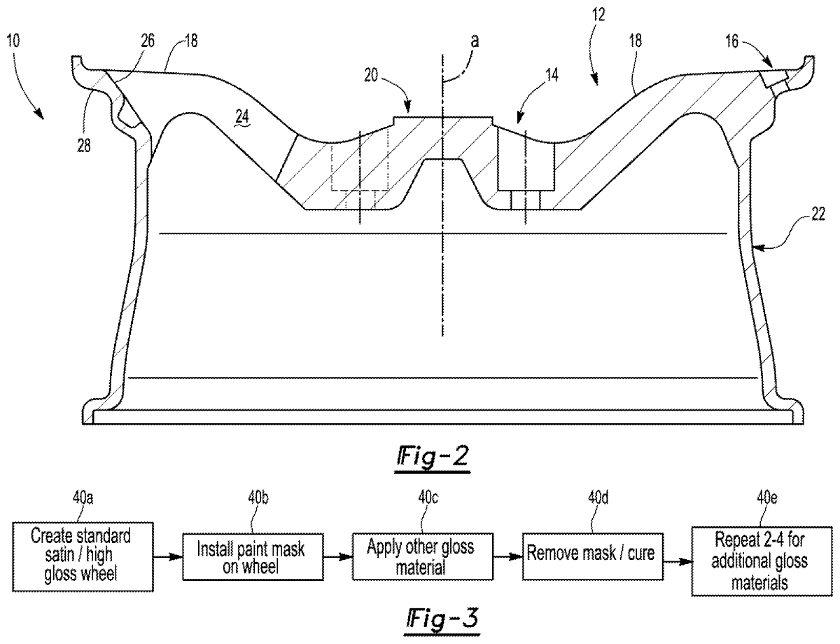

Referring now to FIG. 2, a cross-section of an alloy wheel is generally shown at 10. The wheel 10 is formed via a conventional forming method and optionally includes a face 12 of the wheel 10, which may be machined to form a “bright machined” surface as will be explained further herein below. Additional machine operations to define lug apertures 14 and a valve stem aperture 16 into the face 12 are ncluded and are within the scope of this invention. The face 12 of the wheel 10 includes a plurality of spokes 18 extending from a central portion 20 of the face 12 to a rim 22. The wheel 10 defines a wheel axis a around which the wheel 10 rotates as is well known to those of skill in the art. The wheel 10 also includes three-dimensional configuration having recessed spoke surfaces 24 that define side of the wheel spokes and a visible rim surface 26 of the rim 22.

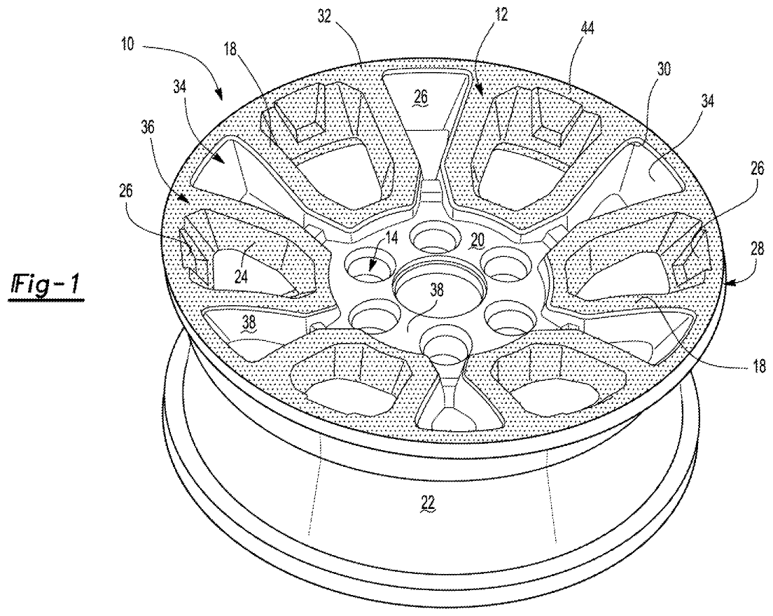

The spokes 18 interconnect with a bead portion 28 defined by the rim 22. Adjacent spokes 18 define an opening 31 between the bead portion 28 and the central portion 20 as is best seen in FIG. 1. The opening 31 exposes the rim surface 26 and the recessed spoke surfaces 24 When viewing the wheel. It should be understood that the depiction of the various wheel surfaces in this application are merely illustrative and not limiting in any way. Different wheel configurations may present alternative rim surfaces 26 and recessed spoke surfaces 24. Further, the rim surface 26 and the recessed spoke surfaces 24 may transition one to the other in a. continuous manner by way of a transitional surface 30. The transitional surface 30 also may separate a facial surface 36 of the face portion 12 from the rim surface 26 and the recessed spoke surface 24. Any one of the aforementioned surfaces 24, 26, 30 may be defined as a first surface 32 or a second surface 34 as will be understood further herein below.

The Wheel 10 shown in FIG. 1 includes the first surface 32 having a first paint finish with a first gloss level and the second surface 34 having a second paint finish having a second gloss level. The first gloss level is different than the second gloss level. In one embodiment, the first gloss level presents a high gloss rating, and the second gloss level presents a mid-gloss rating. Alternatively, the first gloss level presents mid-gloss rating, and the second gloss level presents a high gloss rating. As a. further alternative, the first gloss level presents a matted or low gloss rating, and the second gloss level presents high gloss rating. it should be understood that any combination of gloss ratings may be selected to derive a wheel 10 with a multi-gloss or dual gloss appearance. More than two gloss ratings may be selected on different wheel surfaces 24, 26, 30, 36. Still further, two different gloss levels may be selected within one of the high gloss, mid-gloss low gloss rating ranges to present less contrast between surfaces.

In one embodiment, the wheel 10 is formed, cleaned, and coated in a conventional manner using processes disclosed in co-pending U.S. patent application Ser. Nos. 15/524075 METHOD OF COATING ALLOY WHEELS and 16/256,550 METHOD OF COATING ALLOY WHEELS USING INTER-COAT PLASMA. Therefore, a cast vehicle wheel 10 is cleaned, subject to pretreatment by way of conversion coating to enhance adhesion followed by application of a polymeric primer and color coating. Alternatively, a PVD metal is deposited over the polymeric primer providing a metallic appearance as opposed to a color appearance.

The process by which the multi-gloss wheel 10 is manufactured is shown by way of the flow chart of FIG. 3. After manufacturing the wheel and applying a base polymeric clear or PVD metal, a first polymeric clear coat 38 is applied as identified at step 40a. As set forth above, the first polymeric clear coat 38 is one of a high gloss, mid-gloss, or low gloss rating coating as selected for desired wheel appearance. The first polymeric clear coat coating 38 is selected as a powder coating applied using powder spray equipment in a powder paint booth. After application, the first polymeric clear coating 38 is cured in an oven in a normal manner. After curing, the first polymeric clear coating presents the first gloss level. The first polymeric clear coating 38 includes a thickness of between about 2 mls to 5 mls. It should be understood that the first polymeric clear 38 could also be provided as a liquid spray coating in an alternative embodiment.

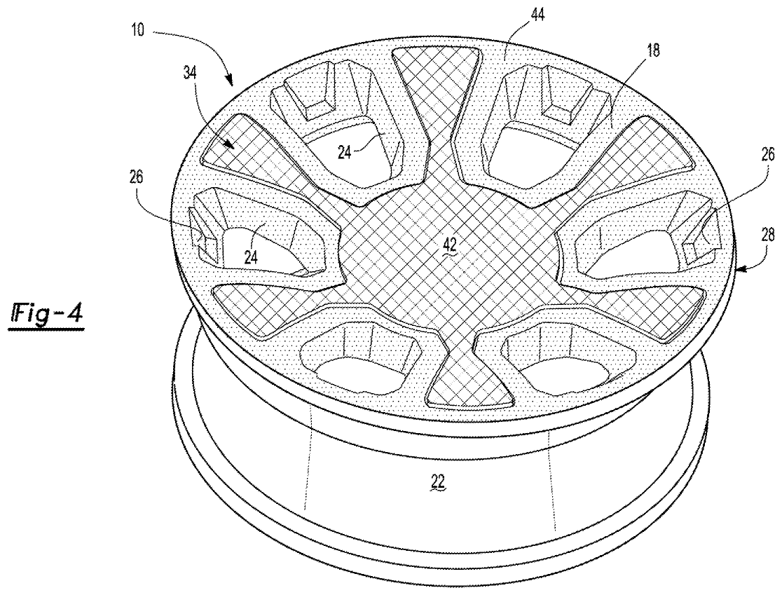

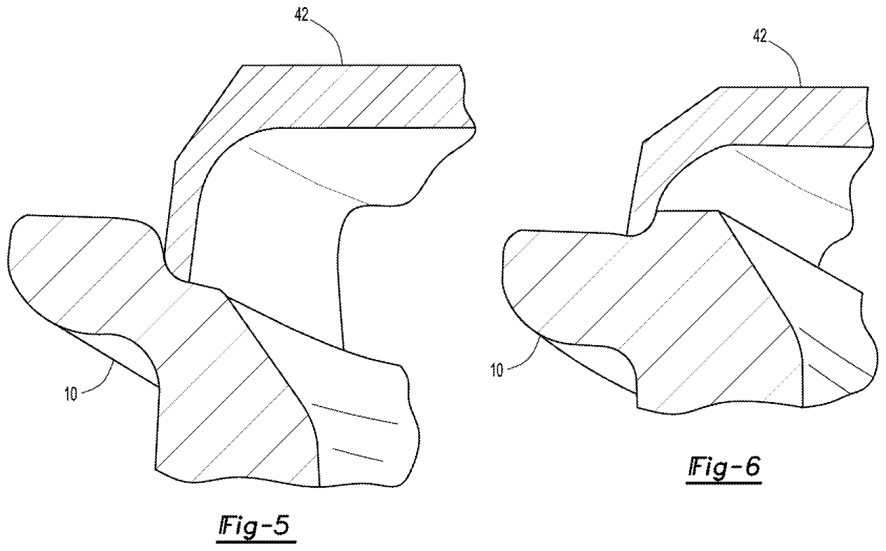

After the first polymeric clear coating 38 is applied and cured, a mask 42 shown in FIG. 4 is placed over the face portion 12 of the wheel 10 to cover a predetermined portion of the first polymer clear coat 38 as identified in step 40b (FIG. 3), Once the mask 42 is placed, a second polymeric clear coat 44 is applied over the exposed first polymeric clear coat 38 as identified at step 40c. The second polymeric clear coat 44 presents a second gloss level that is different than the first gloss level of the first polymeric clear coat 38. In one embodiment, the second polymeric clear coat 44 is a liquid coating. It is believed that application of a liquid coating provides a better opportunity to prevent the second polymeric coating from getting below the mask. 42. However, a powder application form of the second polymeric clear coating 44 is also within the scope of this invention. In one embodiment thickness of the second polymeric clear coating 44 is less than about Itrd, which is substantially lower than the thickness of the first polymeric clear coating 38 that is desired for providing durability to the coating system. However, to improve adhesion of the second polymeric clear coat 44 to the first polymeric clear coat 38, an inter-coat plasma treatment is optionally performed on the first polymeric clear coating 38 prior to application of the second polymeric clear coating 38.

in one embodiment, the second polymeric clear coating 44 is cured in an oven. prior to removing the mask as identified at step 40d. It is believed this sequence of steps will reduce probability of damage to a yet to be cured second polymeric coating 44 that would result in a paint defect. Alternatively, the mask 42 is removed prior to curing the second polymeric clear coat 44 in the oven.

As identified in step 40e, the process steps 40b to 40d maybe repeated to add a third polymeric clear coat over and even a fourth polymeric clear coat over the second polymeric clear coat 44. Additional distinguishing features may also be achieved including adding dyes or pigmentation to the various clear coats 38, 44 to achieve further distinguishing appearance. For example, including a dye or pigmentation to the first polymeric clear coating 38 could present a substantially different appearance or depth than including a dye or pigmentation to the second. polymeric clear coating 42. In each of these embodiments, alternative paint mask 42 configurations are adapted to sealably mask different portion of the wheel l0.

Using the process of the present application, three-dimensional surfaces may achieve unique coating applications presenting multiple gloss appearances. None of the surfaces need be turned or milled to present a different appearance. In one embodiment, the wheel 10 is substantially “as-cast” not being subject to significant machine operation to change the cast contours other than, for example lug and valve apertures. Therefore, the first surface 32 in one embodiment presents a plane of curvature that extends generally in a direction of the wheel axis and the second surface 34 may present a plane of curvature that extends generally in a direction that is perpendicular to said wheel axis. Each of these surfaces may present a different gloss level or portions of a single contoured surface may present multiple gloss levels, all depending upon placement of a mask 42.

The invention has been described in an illustrative manner, and it is to be understood that the terminology that has been used is intended to be in the nature of words of description rather than of limitation. Obviously, many modifications and variations of the present invention are possible in light of the above teachings. It is therefore to be understood that within the specification, the reference numerals are merely for convenience, and are not to be in any way limiting, and that the invention may be practiced otherwise than is specifically described. Therefore, the invention can be practiced otherwise than is specifically described within the scope of the intended claims.

What is claimed is:

1. A vehicle wheel, comprising:
a face portion including a central portion defining a wheel axis and a plurality of spokes extending radially outwardly from said face portion;
a rim portion circumscribing said wheel axis and being interconnected to said face portion by said plurality of spokes:
said face portion and said rim portion. defining a first surface and a second surface; and
said first surface including a paint finish defining a first gloss level and said second surface including a second paint finish defining a second gloss level being different than said first gloss rating.

2. The wheel set forth in claim 1, wherein said first surface presents a plane of curvature that extends generally in a direction of said wheel axis and said second surface present a plane of curvature that extends generally in a direction that is perpendicular to said wheel axis.

3. The wheel set forth in claim 2, wherein a transition is defined between said first surface and said second surface.

4. The wheel set forth in claim 3, wherein said first paint finish and said second paint finish are separated at said transition. The wheel set forth in claim 4, wherein said first gloss level presents a gloss rating of between 80 and 100.

6. The wheel set forth in claim 5, wherein said second gloss level present a gloss rating of between 10 and 70.

7. The wheel set forth in claim 5, wherein said second gloss level presents a gloss rating of between 0 and 10.

8. The wheel set forth in claim 1, wherein one of said first paint finish and said second paint finish is pigmented or tinted.

9. The wheel set forth in claim 3, wherein said transition is disposed upon one of said first surface and said second surface.

10. The wheel set forth in claim 3, wherein said transition is disposed between said first surface and said second surface.

11. A method of coating a vehicle wheel, comprising the steps of:
providing a vehicle wheel having a face portion and a rim portion, said face portion including a central portion and a plurality of spokes extending radially outwardly to said rim portion;
coating said wheel with a first polymeric coating defining a first gloss rating;
applying a second polymeric coating defining a second gloss rating over a portion. of said first polymeric coating thereby providing said vehicle wheel with a multi-gloss appearance defining said first gloss rating said second gloss rating.

12. The method set forth in claim 11, is further defined by said face portion presents a first surface and a second surface.

13. The method set forth in claim 12, further including a step of coating said first surface with said first polymeric coating defining said first gloss rating and coating said second surface with said second coating defining said second gloss rating.

14. The method set forth in claim 11, further including a step of curing said first polymeric coating presenting said first gloss rating prior to applying said second polymeric coating defining said second gloss rating.

15. The method set forth in claim 14, further including a step of applying a mask over said first polymeric coating prior to applying said second polymeric coating thereby shielding a. first portion of said first polymeric coating while applying the second polymeric coating.

16. The method set forth in claim 15, wherein said step of applying a mask over said first polymeric coating is further defined by said mask defining a transition between said first surface and second surface of said face portion.

17. The method set forth in claim 11, wherein said step of applying a first polymeric coating and said step of applying a second polymeric coating is further defined by pigmenting or dyeing at least one of said first polymeric coating and said second polymeric coating.
